(19) United States
(12) Patent Application Publication
(10) Pub. No.: US 2009/0319673 A1
(43) Pub. Date: Dec. 24, 2009

(54) Automated Wireless Device Pairing

(75) Inventor: Mark E. Peters, Chapel Hill, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/109,063

(22) Filed: Apr. 24, 2008

(51) Int. Cl. G06F 15/16

(52) U.S. Cl. 709/228

(57) ABSTRACT

Illustrative embodiments provide a computer implemented method, an apparatus in the form of a data processing system and a computer program product for performing automated wireless device pairing. In one illustrative embodiment, the computer implemented method comprises initiating by one device, detection of a another device and responsive to detecting the another device, transmitting a pairing information as a light signal from the one device to the another device. The computer implemented method further comprises determining whether the another device received the pairing information, and responsive to receiving the pairing information, completing a pairing process to form paired devices.

### BACKGROUND OF THE INVENTION

1. Field of the Invention

The present invention relates generally to an improved data processing system and more specifically to a computer implemented method, an apparatus, and a computer program product for performing automated wireless device pairing.

2. Background Description

A recent development in interactive computing has made a horizontal liquid crystal display table known as a Microsoft® Surface™, from Microsoft Corporation, available to provide a rich user experience. Interaction with pervasive devices and the Surface may be envisioned or anticipated since personal computers, can use wireless devices such as those implementing Bluetooth™ of the Bluetooth Special Interest Group, Inc. to access services on a phone. However, before the devices can be used productively, the user goes through the Bluetooth pairing process by telling the phone and personal computer to look for the other devices and then enter a personal identification number or PIN.

The pairing process is relatively simple. One of the Bluetooth devices is in a discoverable state allowing the other Bluetooth device to detect the presence of the one device. Another or second device looks for or detects the one device. Each device may be placed into a respective mode of detect or detectable by software or menu controls of the respective device. The personal identification number is used to uniquely identify a device to a corresponding device and may be referred to as a pass key, key or code. This code is between one and eight bytes long providing a 16 digit key value. Typical keys are four digits long. Each device uses the same value to complete the pairing. This key is set once and is not required each time the two devices communicate.

Many devices allow for the keys to be selected by the user. Others require the use of a set key provided by the manufacturer. In either case the two devices that are to exchange information are required to use the same key, otherwise no pairing will occur.

For example, in a typical pairing process, the device to be connected to is turned on and set to be discoverable or detectable. A search is then initiated through the other Bluetooth enabled device (perhaps a menu selection). A successful search locates the desired device or other devices as well. The desired device is selected in the interface and the required key code is entered. If the connection is successful a small check mark may appear relative to the image of the connected device. Now a connection may be made next time without the pairing process. The devices are known to each other. The paired devices now have a common linking key which is exchanged each time the devices connect. Paired devices will appear as paired whether the devices are powered or not as well as whether the connection is available.

Differing devices of various manufacturers have different respective ways for establishing settings for detection. Each time a pair of devices communicates for the first time, the different steps in the pairing process are performed to completion.

### BRIEF SUMMARY OF THE INVENTION

Illustrative embodiments provide a computer implemented method, an apparatus, in the form of a data processing system, and a computer program product for performing automated wireless device pairing. In one illustrative embodiment, the computer implemented method comprises initiating by one device, detection of another device and responsive to detecting the another device, transmitting a pairing information as a light signal from the one device to the another device. The computer implemented method further comprises determining whether the another device received the pairing information, and responsive to receiving the pairing information, completing a pairing process to form paired devices.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a mobile camera phone in which illustrative embodiments may be implemented;

FIG. 4 is a block diagram of a surface device, in combination with the device of FIG. 3, in which illustrative embodiments may be implemented;

FIG. 5 is a block diagram of high level components of a pairing system in which illustrative embodiments may be implemented; and

FIG. 6 is a flowchart of a pairing process in accordance with illustrative embodiments.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, and RF.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

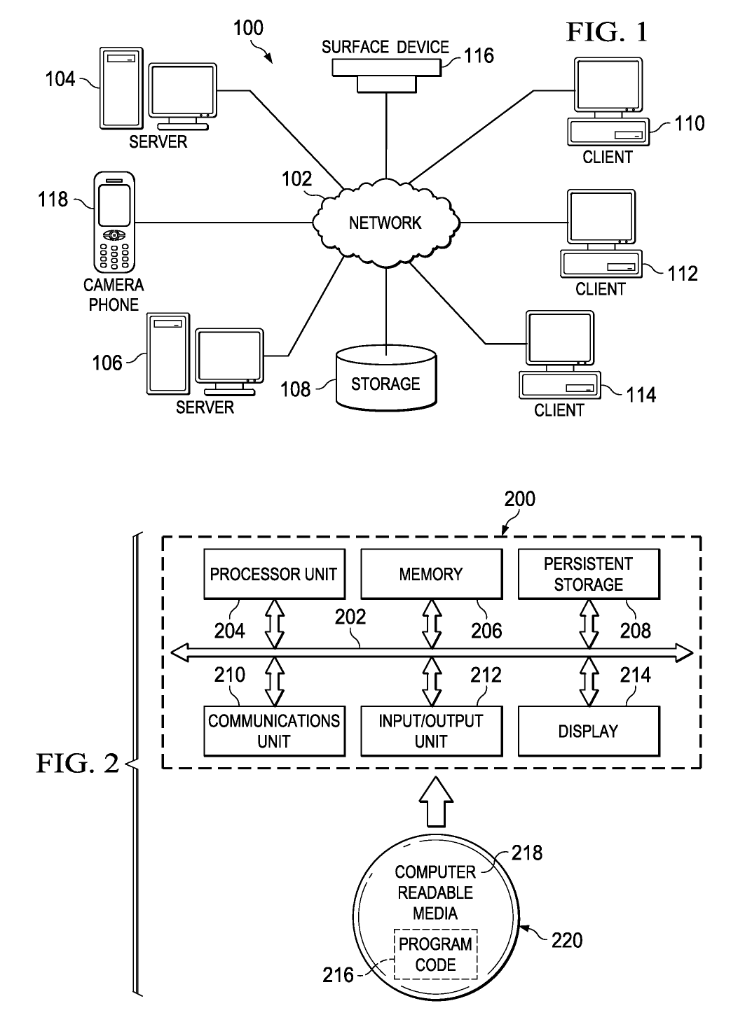

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. Additional devices of surface device 116 and camera phone 118 are also shown connected to network 102. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Surface device 116, for example may be a table layout version of a liquid crystal display device capable of sending and receiving data. Surface device 116 may be represented by the Microsoft® Surface™, available from Microsoft Corporation, table format computing device. Surface device 116 provides a user interface in a table format, representation of a computing device. In simple terms, surface device 116 represents a touch screen made into a table. Surface device 116 can recognize movement through touch, gesture as well as unique objects placed on or near the device. Objects placed on or near the device are able to exchange information. For example, placing mobile camera phone 118 on top of surface device 116 may allow the exchange of contact information between the phone and the device or to traverse network 102 to obtain information from client 114 or server 104 or search for and retrieve from information contained on storage 108. Mobile camera phone 118 has a capability of receiving information from surface device 116 through a lens of the camera device.

In an example, a computer implemented method that performs automated wireless device pairing, such as when Bluetooth devices are paired for communication is provided. The computer implemented method initiates detection, by one device, of another device and responsive to detecting the another device, transmits pairing information as a light signal from the one device to the another device. The method further determines whether the another device received the pairing information, and responsive to receiving the pairing information, completes the pairing process to successfully form paired devices. Bluetooth style devices have been used by way of example, but the features are not intended to be limited to the specific Bluetooth technology and are applicable to other wireless technologies. Wireless device pairing therefore applies to other types of short range wireless devices requiring close proximity, such as that prescribed by Bluetooth necessary for communication.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer recordable storage media. In some instances, computer recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

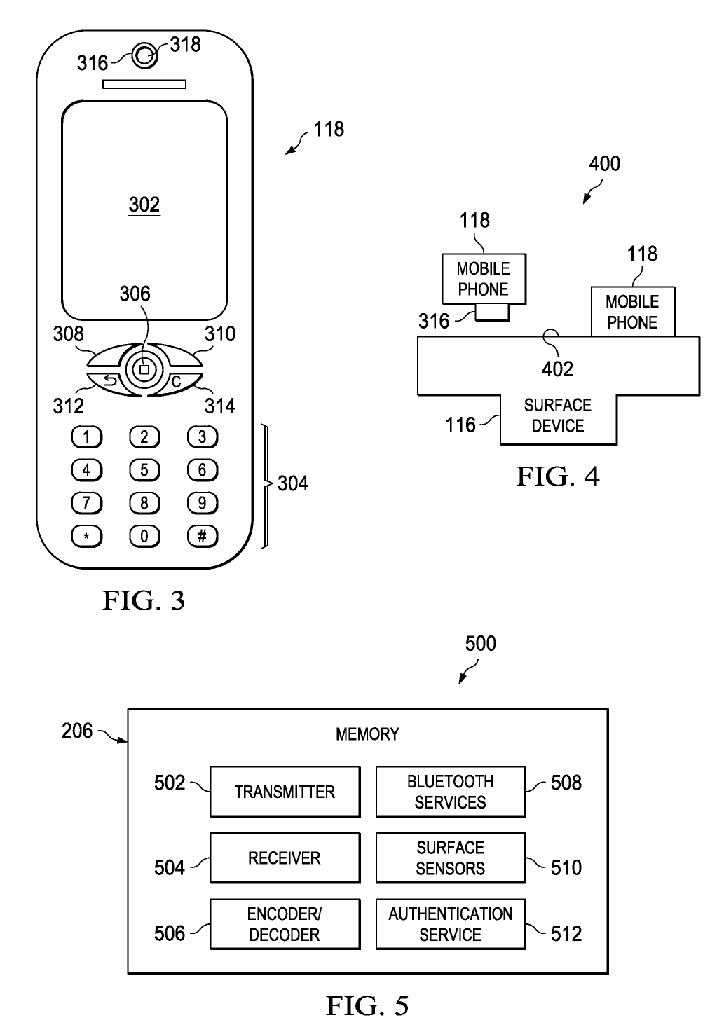

Turning next to FIG. 3, a block diagram of a mobile camera phone is depicted in accordance with an illustrative embodiment. Mobile camera phone 118 includes screen 302, which is capable of displaying pictures and text. Additionally, mobile camera phone 118 also includes numeric keypad 304, joystick 306, and buttons 308, 310, 312, and 314 placed around the joystick 306. These buttons are used to initiate various functions in camera phone 118. These functions include for example, activating a menu, displaying a calendar, or initiating a call. Mobile camera phone 118 also includes camera 316, which may be used to take pictures or videos depending on the implementation.

Camera phone 118 includes components comprising a baseband processor, an application processor, flash or static random access memory (SRAM), flash card, radio frequency integrated circuit, radio frequency module, antenna, a Bluetooth™ unit, color liquid crystal display (LCD) 302, camera 316, and integrated circuit card. Bluetooth is a trademark of the Bluetooth Special Interest Group.

Baseband processor provides for receiver and transmitter operations and is also referred to as a transceiver. In particular, baseband processor handles the entire audio, signal, and data processing needed to receive and send data using radio frequency transmissions or Bluetooth transmissions. Application processor provides the processing power for other functions within mobile camera phone 118. For example, calculators, calendars, alarms, camera functions, and directories are provided through the application processor. Flash or static random access memory is a storage device in which various instructions for providing the functions within mobile camera phone 118 are located and provide upgrades. Flash card is a storage device in which user data and applications may be stored. An example of flash card is a secure digital card.

A pathway for the transmission of voice and other types of data is through a radio frequency integrated circuit. Additionally, short range transmissions may be sent or received through the Bluetooth unit. The Bluetooth unit conforms to the Bluetooth wireless specification, which defines the link layer and application layer for product developers. Both of these transmission types are made through the antenna in this illustrative example.

Color liquid crystal display 302 provides a display for pictures and other data for mobile camera phone 118. Camera 316, in this example, is a complementary metal oxide semiconductor (CMOS) camera, having lens 318, which may be built into mobile camera phone 118 or connected to mobile camera phone 118 as a module, such as integrated circuit card. The integrated circuit card also may contain other application specific functions, such as a global positioning system (GPS) or other functions, such as a modem or additional memory. Camera 316 provides a capability of processing images and other forms of light based signal data. Camera 316 and lens 318 cooperate to form an optical receiver.

Camera 316 forms the camera module of mobile camera phone 118, while the other components form the digital phone module of mobile camera phone 118 in these illustrative examples.

Using the camera of mobile camera phone 118 laid on surface device 116 such as an implementation of Microsoft Surface, enables the surface to display colors or flashes of light that would constitute the personal identification number (PIN) transmitted over Bluetooth during a pairing operation. The result informs the phone of the identifier of the table on which the phone rests. This could be implemented in the table and phone and not require any changes to the Bluetooth protocol itself. The phone could then use Bluetooth to dial voice over Internet Protocol (VOIP) via the Microsoft Surface and use the phone as the audio for the Microsoft Surface. The phone could then use Bluetooth to load address book entries from phone lookups on the Microsoft Surface, to add calendar entries when surfing the internet on the Microsoft Surface, for example.

The pairing would most likely be triggered by Bluetooth, though it could be triggered via the camera or via user selection to pair with Microsoft Surface if the surface device could sense the surface is being used. This same technique could be used to pair an earpiece with the surface. The earpiece could flash it's light emitting diode (LED) in a certain sequence, the Microsoft Surface could observe the flashes, and use that to transmit the correct personal identification number. Voice over Internet protocol in the table could then be used to communicate with the Bluetooth earpiece or headset. This same technique could be used to pair a phone with a Bluetooth earpiece or a personal computer with a Bluetooth device, as long as one of them has a camera.

With reference to, FIG. 4, a block diagram of a surface device, in combination with the phone device of FIG. 3, in which illustrative embodiments may be implemented is shown. Surface device 116 and mobile camera phone 118 of FIG. 1 are shown with mobile camera phone 118 in two positions. In one position, mobile camera phone 118 rests upon top surface 402 of surface device 116. In another position, mobile camera phone 118 is held above the top surface of surface device 116, producing a gap between the two devices. The gap may be several inches and the pairing operation may still be performed. When resting upon the surface, lens 318 of camera 316 of FIG. 3 is in contact with the surface.

In both cases, surface device 116 is able to detect the presence and position of mobile camera phone 118. Further, surface device 116 is likely aware of the type of device and position of lens 318. Surface device 116 also has an optical transmitter capable of sending light signals out through surface 402 to be received by proximate devices such as mobile camera phone 118. Light transmission may be comprised of light signals in a visible spectrum or invisible spectrum and may be in a burst of light signal, a pulse of light signal, a set of light signals, a set of colored signals and a combination of light signals or other means of carrying data as is known. When surface device 116 is not exactly aware of the type of device, surface device 116 could try to establish a Bluetooth pairing. When surface device 116 projects a signal to the entire surface area covered by the device, surface device 116 need not know the exact position of the camera lens.

For example, many charge-coupled device (CCD) and complimentary metal-oxide semiconductor (CMOS) cameras can receive infrared that humans cannot see. Light transmission may be limited to just the camera lens area. If the camera lens area is not exactly known, then the light transmission may cover an area defined to be approximate to the shape of the proximate device. The light transmission may have an internal margin so that light leakage is minimized, thus also minimizing the risk of a human, or other camera, observer from observing the light transmission.

With reference to FIG. 5, a block diagram of high level components of a pairing system in which illustrative embodiments may be implemented is shown. High level components of a Bluetooth pairing system are depicted within memory 206 of data processing 200 of FIG. 2. Components of FIG. 5 may be implemented with hardware, software or a combination. In this example the components are shown within memory 206 as but one non-limiting illustrative embodiment.

Pairing system 500 provides a capability for detecting and recognizing Bluetooth enabled devices, allowing the devices to then exchange data. Transmitter 502 and receiver 504 provide communication capability into and out of surface device 116. In a similar manner, mobile camera phone 118 has similar capabilities for receiving. Encoder/decoder 506 provides encryption and decryption services to allow secure communication to occur between paired devices. Encryption and decryption provide safe exchange of data between two devices after the initial pairing of the devices has succeeded.

Bluetooth services 508 provide the functions required in support of the implementation of the short range wireless protocol. These services include functions to detect devices and to make devices wishing to be found detectable. Detection services poll the area within the short range of the initiating device requesting devices in the proximity to acknowledge. Making a device detectable is setting the device into a mode in which the device will respond to a detection request. For example, a first device broadcasts a request for other devices to acknowledge their presence by responding to the detection request. If a second device has detection enabled, the second device will acknowledge and send a response back to the requesting device. If the second device has detection disabled, the second device will receive the detection request but not reply or ignore and remain unknown to the requesting device. If the second Surface sensors 510 provide feedback information to surface device 116. Feedback includes proximity sensing or positioning of a device on or near the surface of surface device 116. Feedback also includes touch or gesture forms of input. Authentication service 512 provides for verification of devices performing a pairing operation. Successful authentication provides the permission to establish communication between pairs of devices wishing to exchange information. Authentication involves the exchange of security key data. The security key is typically 4 digits long, but under the current standards, the key is usually limited to be between 1 and 8 bytes long.

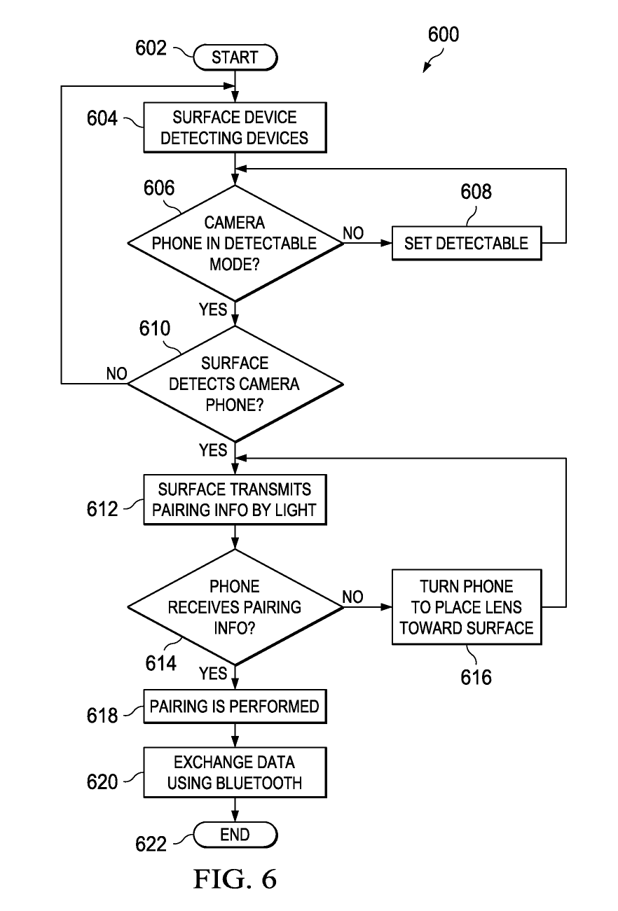

With reference to FIG. 6, a flowchart of a pairing process in accordance with illustrative embodiments is shown. Pairing system 500 of FIG. 5 implements an example of a pairing process 600. FIG. 6 depicts a data flow through a sequence of operations in which a pair of devices may become paired for Bluetooth based data exchange.

Process 600 starts (step 602) and continues with the surface device detecting devices (step 604). In this mode, the one device, the surface device in this example, is broadcasting a signal to locate other devices that may be close by with intentions of communicating. A determination is made as to whether another device, in this example, such as the mobile camera phone, has enabled a “detectable” mode of operation in which case the mobile camera phone produces a “detectable” signal (step 606). If the another device is not “detectable,” a “no” result occurs in step 606, otherwise the another device is made detectable and a “yes” results in step 606. If a “no” was obtained in step 606, the another device is then made “detectable” (step 608) and the process returns to step 606. If a “yes” was obtained in step 606, the detectable mode signal is then received by the one device as in the surface device (step 610).

Surface device then transmits a set of pairing signals to the detected device, such as the mobile camera phone (step 612). The set of pairing signals may be one or more signals required to complete a pairing identification and authentication process. The transmission of the pairing signals is performed using light rather than other signal forms. Use of light restricts the signal to a more confined area to reduce the security risk of another party intercepting a broadcast identification code sequence. If a device such as a mobile camera phone is placed face down, with camera lens facing the surface there is less chance for a signal to be intercepted. Even when the mobile camera phone is held above the surface there is a low risk of the signal interception. The surface device may transmit a color coded signal or other coded light signal in the form of a burst, pulse or set of signals to provide a typically more secure exchange of pairing information. While normal Bluetooth signaling is used for device detection, the light transmission just described may be used to provide added security during the pairing exchange. The light transmission makes it easier for the user since the user does not have to enter the personal identification number. The camera is an example of an optical receiver.

A determination is made whether the camera of the mobile camera phone received the pairing information signals from the surface device (step 614). If the signals were received a “yes” results otherwise no signal causes a “no” result. If the result of step 610 was “no”, then the camera lens may be facing the wrong direction and the phone is rotated to place the lens towards the table (step 616) with the process returning to step 608.

If a “yes” was obtained in step 614, a pairing is performed in which the keys are exchanged and a paired connection established (step 618). Exchange of data using the Bluetooth protocol may then occur (step 620) with the process terminating thereafter (step 622). It is assumed that when the keys are exchanged the correct key was provided for the pairing process to form a match condition otherwise different keys were provided and an error would occur because of the incorrect key use. Normal error processing would be used in this case to resolve the key conflict. Recovery steps include the use of the correct key in a subsequent attempt.

The pairing process of entering access information need not be repeated for the pair of just connected devices. The next time the two devices wish to communicate the devices will be able to do so as known devices. Illustrative embodiments provide a capability to reduce the time and effort required in the pairing process. Since the device, a Microsoft Surface in this example, knows where an object is on the surface, the surface device can use light to communicate with the camera of the mobile camera phone. Transmission of a light signal could replace the entry of a personal identification number to securely pair the Microsoft Surface device with a mobile camera phone using Bluetooth. The light could be restricted to the area that the mobile camera phone and/or the camera lens occupies on the surface device to prevent eavesdropping. In this manner, if the surface device were to display a personal identification number on the table, an onlooker may then see and use the key code to access the phone. The phone still might want to ask for confirmation, but it would be a simple question needing a yes or no response rather than requiring entry of a personal identification number. The light could cover the detected area of the device to reduce the need to locate the camera lens for proper reception of the light signal.

In one illustrative embodiment, a computer implemented method that performs automated wireless device pairing, such as when Bluetooth devices are paired for communication is provided. The computer implemented method initiates detection, by one device, of another device and responsive to detecting the another device, transmits pairing information as a light signal from the one device to the another device. The method further determines whether the another device received the pairing information, and responsive to receiving the pairing information, completes the pairing process to successfully form paired devices. Bluetooth style devices have been used by way of example, but the features are not intended to be limited to the specific Bluetooth technology and are applicable to other wireless technologies. Wireless device pairing therefore applies to other types of wireless devices as well in which close proximity of a short range wireless transmission, such as that prescribed by Bluetooth is necessary for communication.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for performing automated wireless device pairing, the computer implemented method comprising:
initiating by one device, detection of a another device;
responsive to detecting the another device, transmitting a pairing information as a light signal from the one device to the another device;
determining whether the another device received the pairing information; and
responsive to receiving the pairing information, completing a pairing process to successfully form paired devices, wherein data is exchanged.

2. The computer implemented method for performing automated wireless device pairing of claim 1, wherein initiating by the one device, detection of the another device, further comprises:
setting the one device to a detect mode;
determining whether the another device is in a detectable mode; and
responsive to the another device being in other than the detectable mode, setting the another device to the detectable mode.

3. The computer implemented method for performing automated wireless device pairing of claim 1, wherein transmitting a pairing information further comprises:
transmitting a transmission signal from an optical transmitter source of the one device toward an optical receiver of the another device, wherein the transmission signal comprising one of a burst of light signal, a pulse of light signal, a set of light signals, a set of colored signals and a combination of light signals.

4. The computer implemented method for performing automated wireless device pairing of claim 1, wherein transmitting a pairing information further comprises;
transmitting a key code.

5. The computer implemented method for performing automated wireless device pairing of claim 1, wherein completing a pairing process to form paired devices further comprises:
comparing pairing information from the one device with that of the another device to determine a match condition; and
responsive to the match condition forming a linking key to share on subsequent access.

6. A computer implemented method for performing automated wireless device pairing of claim 1, wherein determining whether the another device received the pairing information further comprises:
the another device not receiving the pairing information; and
responsive to the another device not receiving the pairing information, rotating the another device to orient the optical receiver of the another device toward the one device.

7. A data processing system for performing automated wireless device pairing, the data processing system comprising:
a bus;
a memory connected to the bus, the memory comprising computer executable instructions;
a communications unit connected to the bus;
a display connected to the bus;
a processor unit connected to the bus, wherein the processor unit executes the computer executable instructions directing the data processing system to:
initiate by one device, detection of a another device;
responsive to detecting a another device, transmit a pairing information as a light signal from the one device to the another device;
determine whether the another device received the pairing information; and
responsive to receiving the pairing information, complete a pairing process to form paired devices.

8. The data processing system for performing automated wireless device pairing of claim 7, wherein the processor unit executes the computer executable instructions directing the data processing system to initiate by one device, detection of another device, further comprise:
setting the one device to a detect mode;
determining whether the another device is in a detectable mode; and
responsive to the another device being in other than the detectable mode, setting the another device to the detectable mode.

9. The data processing system for performing automated wireless device pairing of claim 7, wherein the processor unit executes the computer executable instructions directing the data processing system to transmit a pairing information further comprises:
transmitting a transmission signal from an optical transmitter source of the one device toward an optical receiver of the another device, wherein the transmission signal comprising one of a burst of light signal, a sequence of light signals, a set of colored signals and a combination of light signals.

10. The data processing system for performing automated wireless device pairing of claim 7, wherein the processor unit executes the computer executable instructions directing the data processing system to transmit a pairing information further comprises:
transmitting a key code.

11. The data processing system for performing automated wireless device pairing of claim 7, wherein the processor unit executes the computer executable instructions directing the data processing system to complete a pairing process to form paired devices further comprises:
comparing pairing information from the one device with that of the another device to determine a match condition; and
responsive to the match condition forming a linking key to share on subsequent access.

12. The data processing system for performing automated wireless device pairing of claim 7, wherein the processor unit executes the computer executable instructions directing the data processing system to determine whether the another device received the pairing information further comprises:
the another device not receiving the pairing information; and
responsive to the another device not receiving the pairing information, rotating the another device to orient the optical receiver of the another device toward the one device.

13. A computer program product for performing automated wireless device pairing, the computer program product comprising:
a computer-usable medium tangibly embodying computer executable instructions thereon, the computer executable instructions comprising:
computer executable instructions for initiating by one device, detection of a another device;
computer executable instructions responsive to detecting another device, for transmitting a pairing information as a light signal from the one device to the another device;
computer executable instructions for determining whether the another device received the pairing information; and
computer executable instructions responsive to receiving the pairing information, for completing a pairing process to form paired devices.

14. The computer program product for performing automated wireless device pairing of claim 13, wherein computer executable instructions for initiating by one device, detection of a another device, further comprises:
computer executable instructions for setting the one device to a detect mode;
computer executable instructions for determining whether the another device is in a detectable mode; and
computer executable instructions responsive to the another device being in other than the detectable mode, for setting the another device to the detectable mode.

15. The computer program product for performing automated wireless device pairing of claim 13, wherein computer executable instructions for transmitting a pairing information further comprises:
computer executable instructions for transmitting a transmission signal from an optical transmitter source of the one device toward an optical receiver of the another device, wherein the transmission signal comprising one of a burst of light signal, a sequence of light signals, a set of colored signals and a combination of light signals.

16. The computer program product for performing automated wireless device pairing of claim 13, wherein computer executable instructions for transmitting a pairing information further comprises:
computer executable instructions for transmitting a key code.

17. The computer program product for performing automated wireless device pairing of claim 13, wherein computer executable instructions for completing a pairing process to form paired devices further comprises:
computer executable instructions for comparing pairing information from the one device with that of the another device to determine a match condition; and
computer executable instructions responsive to the match condition for forming a linking key to share on subsequent access.

18. The computer implemented method for performing automated wireless device pairing of claim 13, wherein computer executable instructions for determining whether the another device received the pairing information further comprises:
the another device not receiving the pairing information; and
computer executable instructions responsive to the another device not receiving the pairing information, for prompting a user to rotate the another device to orient the optical receiver of the another device toward the one device.
